(19) United States
(12) Patent Application Publication
(10) Pub. No.: US 2004/0216031 A1
(43) Pub. Date: Oct. 28, 2004

(54) Verifying the veracity and creator of a printed document

(76) Inventor: Clark N. Taylor, La Jolla, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/424,248

(22) Filed: Apr. 28, 2003

(51) Int. Cl. G06F 15/00

(52) U.S. Cl. 715/500

(57) ABSTRACT

A technique for identifying whether information in an original document has been altered in a copy thereof is described. A creator identifies the pertinent information in an original document, where the pertinent information may include image and text information. This pertinent information is encrypted and reduced to a verification mark such which is added to the original document. The pertinent information can be compressed prior to encryption. A verifying party receives a copy of the document along with an appended verification mark. The verification mark is decrypted and the information contained in the verification mark is reproduced and compared with the information contained in the copy. Any discrepancy between information contained in the verification mark, which is known to be true, with information in the copy indicates that the copy may have been altered.

### TECHNICAL FIELD

The present disclosure relates to document reproduction, and more particularly, determining the authenticity and veracity of a reproduced document.

### BACKGROUND

High quality reproduction of documents continues to evolve with higher resolution copier devices, facsimile machines, printers, and multi-function devices. Users are able to reproduce and share high quality documents that may be indiscernible from an original document.

The ability to reproduce high quality copies has found numerous and legitimate uses. Parties are able to reproduce legal documents, such as contracts, and share them with others. Merchants are able to increase promotions by allowing customers to copy and share coupons, such as coupons made available on-line on a merchant's website. When a party requests verification from an individual, the individual is able to photocopy a driver's license or passport and provide a copy to the requesting party.

The advance of high resolution scanners, computers, and application programs, have allowed numerous illegitimate users to forge, manipulate, and pass on documents as true copies of the original document. A malicious party is able to scan a document into a computer, and using particular application programs alter or doctor the document. The altered document is then produced as a hard or printed copy and passed on as a true copy of the original document.

Particular examples of illegitimate uses include altering a legal document such as a contract, changing significant terms (e.g., price conditions), and submitting a printed copy to an unsuspecting party. A malicious party may scan a merchant's coupon and change the value of the coupon (e.g., 10% off changed to 90% off) and present the altered coupon for redemption. A malicious party may be asked for identification as part of a loan application and provide a copy of another person's driver's license with a picture of someone else substituted for the actual person on the driver's license.

Several methods and techniques exist to differentiate original documents and copies of the original document. Examples include adding a watermark, hologram, or similar mark to an original document. Copies made from the original document do not show the watermark, hologram, or similar mark. In other cases, a mark is created on copied documents that identifies them as copies of an original document (e.g., a watermark appears on a photocopied check).

In the illegitimate examples discussed, an unsuspecting party knows that a copy has been presented. The concern, however, is to determine if the presented copy is a true copy that contains the same information as in the original document.

Verifying a true copy may be separated into two classifications, authentication and veracity. Verification of the original creator or author may be defined as authentication. In certain cases a copy of an original document may be presented and authenticated with the original creator, however, the copy may have been doctored from the original. Although authentication is verified, the veracity or knowing whether the original document was not modified is at question.

Accordingly, this invention arose out of concerns associated with providing the ability to allow a party that receives a copy of an original document to verify the copied document's authenticity and veracity.

### SUMMARY

The systems and methods described herein include identifying creator defined pertinent information such as images and texts in a document. This pertinent information is to be protected from alteration and is encrypted. The encrypted information is reduced to a verification mark that is appended to the original document.

Certain systems and methods described include receiving a hard or printed copy of the document with the appended verification mark and reducing the copy and the verification mark to a computer readable format. The pertinent information in the verification mark is decrypted and the pertinent information that is known to be true is used to create a document that is compared to the copy that may have been altered. Certain embodiments provide for displaying both the created document and the copy to a verifying party or identify only those areas of concern that represent pertinent information.

In particular embodiments, creator information such as name or identification number are encrypted and added to the verification mark.

In certain embodiments, information including pertinent information, creator information, and/or fiducial marks is compressed by the creator prior to being reduced to the verification mark. The compressed information is later decompressed.

### BRIEF DESCRIPTION OF THE DRAWINGS

The drawings that are shown and described are to illustrate embodiments and/or implementations of the invention, and are not of the invention itself.

FIG. 1 is a block diagram illustrating an exemplary original document that is copied.

FIG. 2 is a flowchart illustrating the creation of a verification mark such as a barcode that is associated with a document.

FIG. 3 is a block diagram illustrating an exemplary document that includes a verification mark such as a barcode.

FIG. 4 is a flowchart illustrating the verification of a copied document as to its validity.

FIG. 5 is a block diagram illustrating an exemplary system to create a verification mark and to verify a copied document as to its validity.

### DETAILED DESCRIPTION

### Exemplary Document

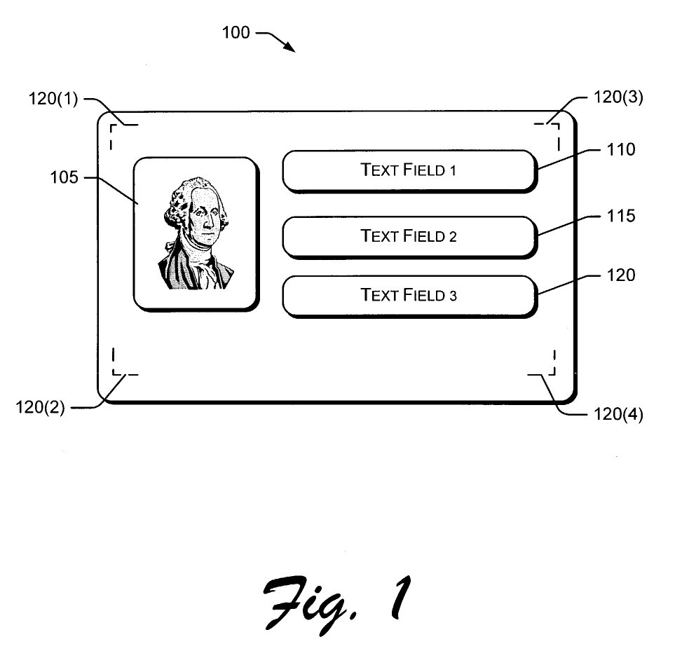

FIG. 1 shows an exemplary original document 100 that is copied. Document 100 may be an identification (ID) card such as a driver's license, a passport, or a company ID card. Document 100 may also be a legal document that includes numerous pages. In certain cases, document 100 is a redeemable coupon issued by a merchant. Document 100 is reduced to a printed or hard copy version that may be copied and submitted to various parties.

Document 100 includes various fields that contain information. In this example, document 100 includes a graphics or image field 105. Image field 105 may be a picture of a person associated with a particular ID card. Image field 105 may also be a graphics image representing a logo or a trademark of a particular merchant. The size of image field 105 is dictated by the complexity of the images that are contained in image field 105. The complexity of image 105 in turn is dictated by factors that include the number of pixels, the number of colors, and/or the number of grayscale shades contained in image 105.

Included in document 100 are various text fields. In this example three text fields are included: “text field 1” 110, “text field 2” 115, and “text field 3” 120. Text fields 110, 115, and 120 can include different information regarding document 100. In the example where document 100 is an ID card, “text field 1” 110 may contain the name of a person for which the ID card is issued; “text field 2” 115 may contain an address of the individual; and “text field 3” 120 may contain an assigned ID number such as a social security number. In the example of a legal document, “text field 1” 110 may contain the names of the parties; “text field 2” 115 may contain a first set of terms and/or conditions; and “text field 3” 120 may contain a second set of terms and conditions. In the example where document 100 is a coupon, “text field 1” 110 may contain the name of an issuing merchant; “text field 2” 115 may contain description as to the item that the coupon applies to; and “text field 3” 120 may contain a value as to the percentage off from the particular item.

Text fields may vary in size. The size of a text field is dictated by the type or amount of information contained in the text field. For example, a text field that contains a person's name as part of an ID card is a relatively small text field. A text field in a legal document that contains long paragraphs or sections containing information relevant to terms and conditions is a relatively large text field.

It is desirable to protect particular image and/or text fields from alteration. The amount of protection or the need to protect certain image and/or text fields from alteration varies depending on the verification needs of parties that received copied documents (i.e., verifying parties). For example, for coupons, it may not be necessary to prevent alteration of a graphics field that contains a merchant's logo. The merchant can readily identify alterations of the logo or may not care if the logo on the coupon has been altered. However, a merchant does care if the redemption value of the coupon has been altered. A malicious party may alter the text field containing redemption value, and present the altered coupon to an unsuspecting clerk of the merchant. Therefore, depending on the application or need for protection there may be pertinent information, not so pertinent information, and impertinent information as contained in the various image and text fields of a document.

When a document is copied or scanned into an electronic computer readable form, frames of reference may be needed to determine where particular image and text fields are located on the document. Document 100 includes fiducial marks 120(1)-120(4) that provide computer readable frames of reference for document reproduction. Fiducial marks 120(1)-120(4) may be defined by a Cartesian coordinate or similar system. Since only a computer needs to know the location of fiducial marks 120(1)-120(4) they may be made invisible to a user. Creation of Verification Mark

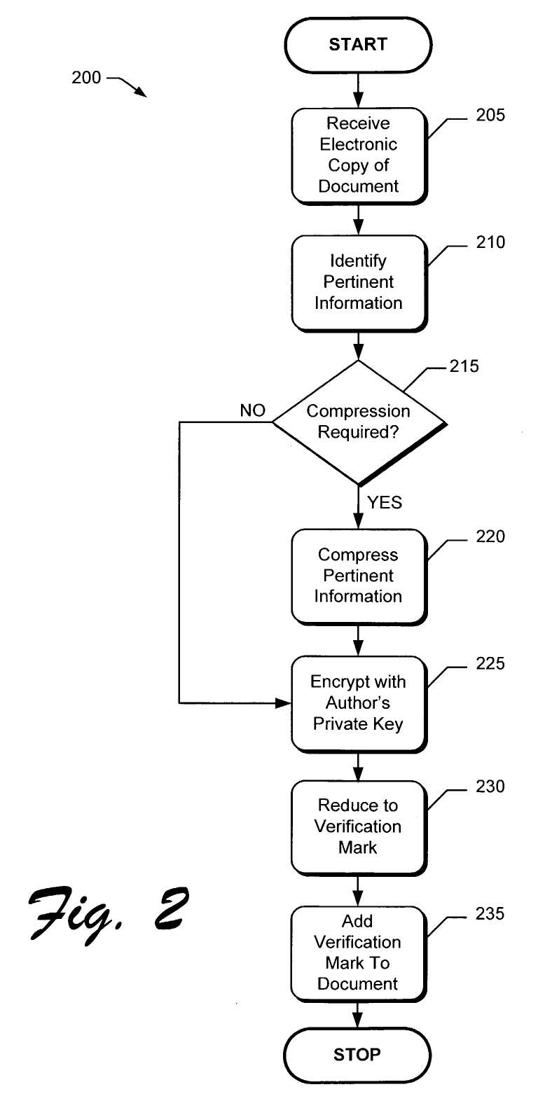

FIG. 2 shows a process 200 for creating a verification mark such as a barcode that is added or appended to a document. Blocks of process 200 represent computer executable instructions that may be performed on a computing device, such as a personal computer, by a creator of a protected document.

At block 205, an original document or a true copy of the original document is either scanned into an electronic computer readable version, or a computer readable version of the original document is received by a creator. The creator creates a verifying mark for the document. The creator may or may not be the original author of the document. In certain cases the creator may be a party that is responsible for assuring the protection of the document. The electronic copy of the original document is divided or separated into various image and/or text fields containing different information.

At block 210, depending on the need to protect certain information from alteration, the creator identifies the pertinent information to be protected. In particular, the pertinent information is defined by particular image and/or text fields containing the pertinent information. It is sometimes desirable to minimize the size of a verification mark that is attached to a document. In certain cases, space constraints prevent verification marks to be no larger than a particular size (e.g., a driver's license has limited space to add a verification mark). Therefore it is ideal to identify a minimum number of image and/or text fields that will provide protection for the document. The creator may through a user interface identify particular image and/or text fields as pertinent information. If verification mark size is a concern, only the pertinent information may be protected. In order to limit the size of the verification mark impertinent information and not so pertinent information contained in image and text fields are not protected. However, in certain cases, pertinent information may be so detailed and contain so much information as to make it impossible to reduce the information needed for protection of the document. Such pertinent information may be compressed.

At block 215, a determination is made as to the need to compress the identified pertinent information. A predetermination may be made as to the size of the verification mark that is attached to the document. In certain cases, a creator may determine that it is important to protect and include as much information in image and/or text fields as possible. The predetermined size of the verification mark and/or metrics set forth by the creator dictates whether compression is needed. If the pertinent information to be protected “fits” into the verification mark, no compression is needed (i.e., the “NO” branch is from block 215), otherwise compression is performed (i.e., the “YES” branch from block 215).

At block 220, compression is performed on pertinent information as contained in identified image and/or text fields. Various compression techniques may be used, including both lossy and lossless techniques. Depending on the ability to reproduce and properly identify pertinent information, particular compression techniques are chosen. In other words, it may not be acceptable to apply lossy compression to pertinent information if there is a chance that important data will be dropped from the pertinent information. A particular example where lossy compression may not be acceptable includes a text field that identifies a name, since any slight variations (i.e., data drops) may cause significant changes in the name. Certain cases may allow for lossy compression, such as compressing an image in an image field and sufficiently allowing an acceptable and recognizable image to be reproduced using the compressed information. Block 220 may also include compressing information related to fiducial marks. In particular cases fiducial marks do not take up significant data space and do not need to be comprised. Fiducial marks are used in recreating images and compensating for any image variances.

At block 225, encryption is performed on the pertinent information, whether it may be compressed or uncompressed. It is contemplated that encryption may be performed using well known asymmetric private/public key encryption methods; however, other encryption methods, such as symmetric encryption, may be used. In the asymmetric private/public key encryption method, the compressed or uncompressed pertinent information is encrypted using a private key known by the creator. Symmetric encryption allows a creator and a verifier to use the same key.

At block 230, the encrypted pertinent information is reduced to a verification mark. One example of a verification mark is a two dimensional barcode. If fiducial mark information has not been added to this point, it can be added as part of the verification mark. The verification mark contains encrypted compressed or uncompressed information that may be read by a reader or scanner. The verification mark information is translated to an electronic or computer readable document that is a minimal representation of the original document and contains all the necessary pertinent information that is protected from alteration. Certain embodiments provide that a name or identification that associates the creator is encrypted and added to the verification mark. This information may be added as part of a visible or a hidden text field. This allows subsequent verifying parties to authenticate the creator of the protected document. Encrypting creator information using symmetric encryption allows a malevolent verifier to decrypt the information, modify the information, re-encrypt the information (with its information), and present the information as authenticate. Adding encrypted creator information, however, may be useful when presenting the document as originating from a particular creator. In this case, asymmetric encryption is used. In certain cases, other creator verification methods may be available that makes encrypting creator information redundant. A particular case is when the verifier directly requests a key from a creator. In this case, the verifier knows that the creator is valid or true.

At block 235, the verification mark is added or appended to the document. The verification mark is now part of the document and is seen on any subsequent copies that are made of the document.

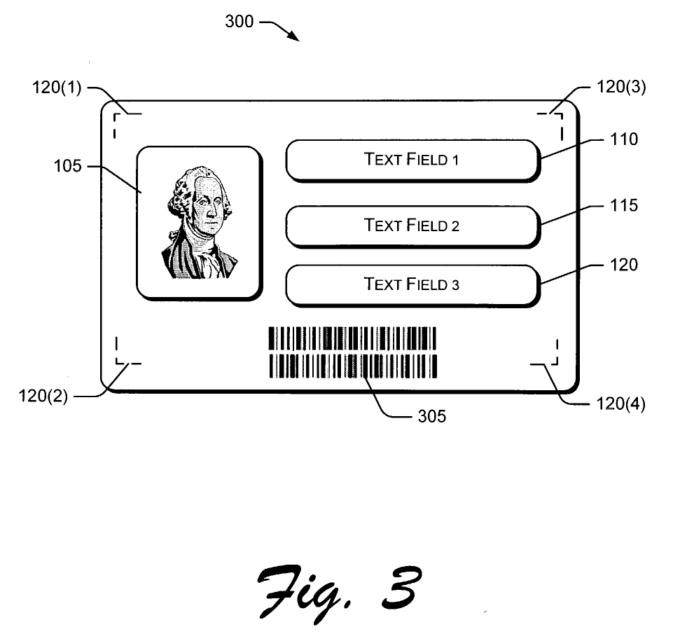

FIG. 3 shows an exemplary protected document 300 with an appended verification mark or barcode. Protected document 300 contains the same information as document 100 of FIG. 1; however, a two dimensional verification mark 305 is added. Verification mark 305 is placed on a location in document 300 such that verification mark 305 would not overwrite nor be obtrusive to any other existing information on shown on document 100. Verification mark 305 contains compressed or uncompressed information that is encrypted. It is contemplated that verification marks, such as verification mark 305, be reproducible when copied, and may be read and transformed into computer readable information.

### Verification of Document

A copy of a document such as protected document 300 of FIG. 3 can be subsequently presented to a verifying party. The verifying party does not know if the presented copy is a true copy of the original document. The verifying party desires to know if pertinent information has been changed from the original document. The verifying party may also desire to know if the presented copy is from the true creator.

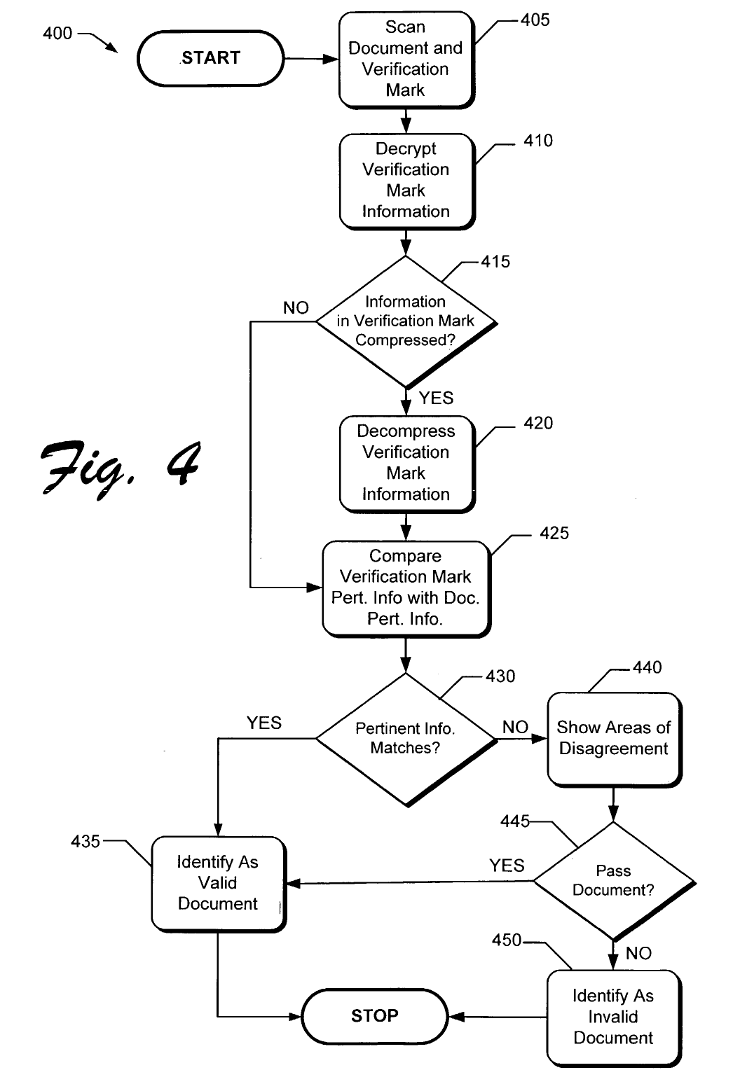

FIG. 4 shows a process 400 for verifying a document. Blocks of process 400 represent computer executable instructions that may be performed on a computing device, such as a personal computer by a verifying party.

At block 405, the presented copy is scanned along with the appended verification mark. Scanning reduces the hard copy document to an electronic computer readable form. The computer readable version of the document in particular contains image and/or text fields that are compared to image and/or text fields that are reproduced using the appended verification mark.

The parts of the copied document, except for the verification mark, are not encrypted. In this particular example, the verification mark has been encrypted using an asymmetric private/public key encryption method. As discussed above, a private key known by the creator is used to encrypt the information. At block 410, decryption is performed using a public key that is paired with the private key. The public key is known by the verifying party and other parties, and allows decryption of the information contained in the barcode. It is contemplated that other encryption methods, such as symmetric encryption, may be used in lieu of asymmetric private/public key methods.

At block 415, a determination is made whether the information in the verification mark had been compressed. A verifying party has predetermined information as to whether compression is used, and if so the type of compression used.

If the decrypted barcode information was not compressed (i.e., the “NO” branch), comparison of pertinent information contained in the verification mark and in the scanned document is compared. If the decrypted barcode information has been compressed (i.e., the “YES” branch of block 415), at block 420, decompression is performed on decrypted compressed barcode information. Depending on the particular compression method that was used to compress the barcode information, a particular decompression method is performed. Typically, the decompression method makes use of an inverse algorithm of the method that was used to compress the original information. In certain compression/decompression methods a lookup table is incorporated. For lossless compression methods all the data that was compressed is recreated. However, for lossy compression methods, some of the data that was compressed is lost. It is contemplated that any compression method, whether it be lossy or lossless, provide enough data to perform adequate comparison of pertinent information, and in certain cases the identification of creator name/identification.

Pertinent information, in particular image and/or text fields, contained in the decrypted decompressed barcode is used to reproduce a representation of the original document. Part of the reproduction may include the use of fiducial marks to properly align or place the reproduced text and/or image fields. For example, the use of fiducial marks may be necessary to distinguish particular text fields. In other words, aligning the text fields is necessary to assure that comparison is performed on the same text fields. The representation of the document as produced from the barcode information may be presented to the verifying party to allow a visual comparison to the presented copy of the document. Alternatively, only areas of concern or the pertinent information is presented or looked at.

At block 425, the scanned document with image and/or text fields containing pertinent information is compared to the reproduced representation created from the decrypted decompressed barcode information. Block 425 may also include authenticating the creator of the document by comparing decrypted decompressed creator name/identification information. As discussed above, in certain embodiments, the creator name/identification may be contained in a visible or hidden text field. In certain cases the verifying party has available the creator name/identification to perform authentication.

At block 430, pertinent information image and/or text fields are compared. The image and/or text fields reproduced from the barcode information contain the pertinent information as contained in the original document. The presented copy may have been altered by a malicious party. The verifying party, however, is only concerned if the identified pertinent information image and text fields have been altered. Therefore corresponding pertinent image and/or text fields of the scanned document are compared to corresponding fields of the reproduced image from the barcode. If all pertinent image and/or text fields match (i.e., the “YES” branch of 430), then the document may be valid. If any of the pertinent image and/or text fields fail to match (i.e., the “NO” branch of 430), then the document may be invalid.

At block 435, after successful comparison of the reproduced barcode image and the scanned image, an indication is made that the presented copy of the document is valid as to the pertinent information contained in the original document, and in certain cases the authenticity of the creator of the protected document.

At block 440, if discrepancies exist as to veracity based on pertinent information image and/or text fields, and/or in certain cases the authenticity of the creator of the protected document, an indication is made as to the areas of disagreement (e.g., where pertinent information does not match). This may be performed with manual inspection of the presented document and the reproduced barcode document. However, in certain cases, a false indication may exist as to a comparison between certain image and/or text fields. For example, a presented copy of a document may have an extraneous line drawn across an image field. When the particular image field that may contain a person's photo is scanned in and compared to the image field information contained in the verification mark information, the extraneous line causes the respective image fields to not match.

Based on the areas of disagreement a verifying party may decide whether the discrepancies are substantial or minor. At block 445, if the decision is made that the discrepancies are minor, the document is indicated as a valid document as indicated by block 435(the YES branch of 445 is followed). If the discrepancy is substantial, block 450 indicates that the document is invalid (the NO branch of 445 is followed).

### Exemplary System for Creating and Verifying Documents

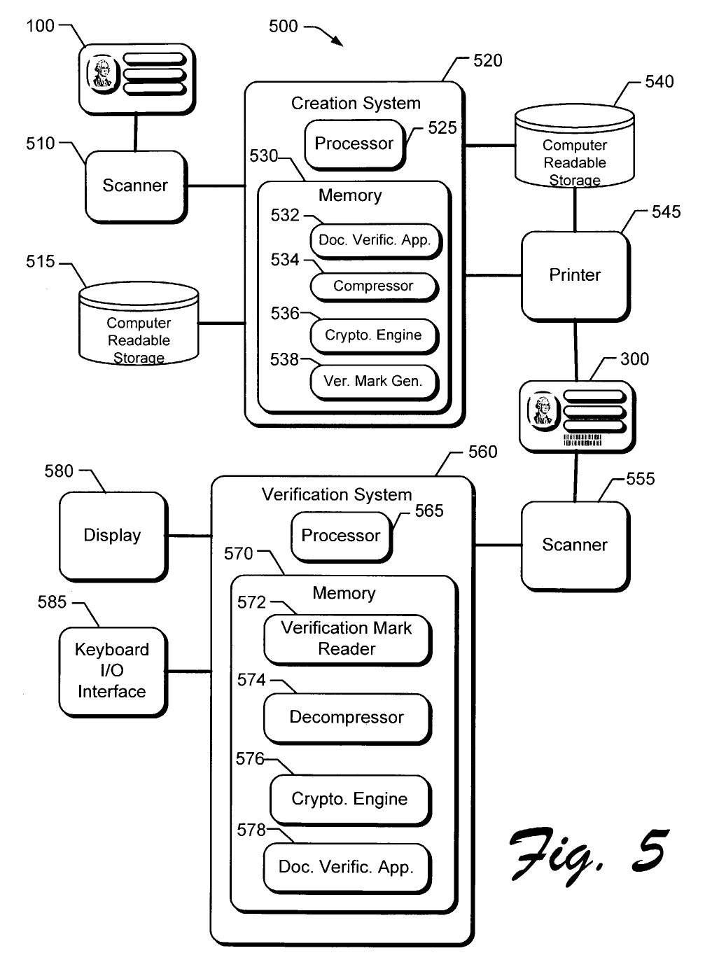

FIG. 5 shows an example of a system 500 that creates and verifies a protected document. An original document, such as document 100 as shown in FIG. 1, may be received by a scanner 510 and reduced to an electronic computer readable version. Alternatively a computer readable version of document 100 may be stored in storage 515.

A creation system 520 receives the computer readable version of the document. Included in the creation system 520 is a processor 525 that is coupled to a memory 530. Memory 530 can include protected hardware including various “smartcard” devices. Memory 530 includes a number of program modules. In particular, memory 530 includes a document verification application module 532 that identifies image and or text fields in the computer readable version of the document. Verification application module 532 may also be used in identifying fiducial marks and other information used to reconstruct the document. A compressor module 534 may be used to compress identified pertinent information. Compressor module 534 may make use of lossy or lossless compression algorithms. A cryptographic engine 536 is used to encrypt pertinent information. In certain cases, the cryptographic engine 536 makes use of a private key that is only known by the creation system 520, or in symmetric encryption a common key is used. The encrypted pertinent information is reduced to a verification mark by verification mark generator 538 of memory 530.

The computer readable version of the document along with the generated verification mark which is appended onto the document may be sent to a computer readable storage 540 or sent directly to a printer 545. Printer 545 produces a hardcopy of the document having the appended verification mark such as document 300 shown in FIG. 3. Protected document 550 may be copied a number of times by various copying devices such as scanners, photocopiers, and facsimile devices.

Protected document 550 or copies of protected document 550 are presented to a verifying party. The verifying party reduces protected document 550 or its copy to a computer readable version by reading it through a scanner 555 or similar reading device. In particular, scanner 555 reads the document and appended verification mark included in protected document 550.

The computer readable version of protected document 550 which includes the appended verification mark is received by verification system 560. Verification system 560 includes a processor 565 that is coupled to a memory 570. Memory 570 can include protected hardware including various “smartcard” devices. Memory 570 includes a number of program modules. In particular, memory 570 includes a verification mark reader module 572 that reads the computer readable version of the verification mark. A decompressor module 574 may be used to decompress the verification mark. Decompressor module 574 contains predetermined information as to the compression algorithm or method that may have been performed by compressor 534 of creation system 520. It follows that decompressor module 574 will have the necessary decompression algorithm to decompress any compressed information. A cryptographic engine module 576 is used to decrypt the verification mark. In the case of private/public key encryption, a known public key is used by cryptographic engine module 576 to decrypt the verification mark. Document verification application module 578 is used to recreate the scanned document, in particular to recreate a document displaying the pertinent fields, based on the verification mark. A comparison is made as to the pertinent fields identified in the verification mark and those shown in the scanned document.

A verifying party may be provided with a visual comparison of the scanned document and the document recreated from the verification mark through a display 580. As discussed above, a false indication may exist as to a comparison between certain image and/or text fields.

A verifying party may be able to identify trivial differences that may have led to identifying mismatches of pertinent field information. For example, a line across a photograph of a scanned protected document may lead to an error. The verifying party is able to recognize this trivial difference on the display 580. The verifying party may also be provided an input output device such as keyboard 585 to verification system 560. If all other pertinent information image and/or text fields match, the verifying party may accept the presented document. The keyboard 585 allows the user to accept or reject trivial differences that may have resulted in false comparisons of particular pertinent information fields.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
encrypting pertinent information extracted from a document;
reducing the encrypted pertinent information to a verification mark; and
appending the verification mark to the document.

2. The method of claim 1 wherein the pertinent information is contained in at least one of an image field and a text field.

3. The method of claim 1 wherein the encrypting is performed using a private key as part of an asymmetric private/public key pair encryption method.

4. The method of claim 1 wherein the encrypting is performed using a key as part of a symmetric encryption method.

5. The method of claim 1 wherein the verification mark is a barcode.

6. The method of claim 1 further comprising compressing the pertinent information prior to said encrypting.

7. The method of claim 6 wherein the compressing is performed using a lossless compression method.

8. The method of claim 6 wherein the compressing is performed using a lossy compression method.

9. The method of claim 1 further comprising encrypting information related to a creator of the document and including the encrypted creator information as part of the verification mark.

10. The method of claim 9 further comprising compressing the creator information prior to encrypting.

11. A method comprising:
receiving a first document and a verification mark derived from encrypted information obtained from the first document;
reducing the first document and the verification mark to a computer readable format;
decrypting the encrypted information;
creating a second document from the decrypted pertinent information; and
comparing the first and second documents.

12. The method of claim 11 wherein the encrypted information is contained in at least one of image fields and text fields.

13. The method of claim 11 wherein the encrypted information is encrypted using a private key of a private/public key pair and the decrypting is performed using a public key of the private/public key pair.

14. The method of claim 11 wherein the same key as used for the encrypted information is used for the decrypting as part of symmetric encryption.

15. The method of claim 11 wherein the verification mark is a barcode.

16. The method of claim 11 wherein the encrypted information in the verification mark is compressed prior to being encrypted; and further comprising decompressing the information after the decrypting.

17. The method of claim 11 wherein the verification mark further comprises encrypted information related to a creator of the first document.

18. The method of claim 11 further comprising displaying the first and second documents to a verifying party.

19. The method of claim 11 further comprising displaying areas of disagreement between the first and second documents to a verifying party.

20. The method of claim 19 further comprising allowing the verifying party to pass the first document if areas of disagreement are shown.

21. One or more computer-readable media containing computer program instructions comprising instructions for:
receiving a document that includes image and text fields;
identifying pertinent image and text fields in the document;
encrypting the pertinent image and text fields;
creating a verification mark based on the pertinent image and text fields; and
appending the verification mark to the document.

22. The computer-readable media of claim 19 further comprising instructions for compressing the pertinent image and text fields prior to encrypting.

23. One or more computer-readable media containing computer program instructions comprising instructions for:
creating a computer readable version of a hard copy of a document appended with a verification mark that contains encrypted information;
decrypting the encrypted information contain in the verification mark;
creating a document based on the decrypted information; and
comparing the computer readable version with the created document based on the decrypted information.

24. The computer-readable media of claim 19 further comprising instructions for decompressing encrypted information that has been compressed.

25. A computing device comprising:
a processor;
a memory to store a document;
a document verification application module stored in memory executable on the processor to identify image and text fields of the document;
a cryptographic engine module stored in memory executable on the processor used to encrypt the identified image and text fields; and
a verification mark generator module stored in memory executable on the processor used to create a verification mark.

26. The computing device of claim 24 further comprising a compressor module stored in memory executable on the processor used to compress the image and text fields prior to encryption

27. A computing device comprising:
a processor;
a memory;
a verification mark reader module stored in the memory executable on the processor to read a verification mark that is part of a document;
a cryptographic engine module stored in the memory executable on the processor to decrypt the verification mark; and
a document verification module stored in the memory executable on the processor to create a document based on information contained in the verification mark.

28. The computing device of claim 26 further comprising a decompressor module stored in the memory executable on the processor to decompress compressed information in the verification mark.

29. A system comprising
a creation device to create a protected document that includes a verification mark, wherein the verification mark comprises pertinent information fields of an original document; and
a verification device to scan the protected document and the verification mark, wherein the verification mark is used to recreate a document based on the pertinent information and the recreated document is compared with the scanned protected document.
